(19) United States
(12) Patent Application Publication
(10) Pub. No.: US 2025/0291880 A1
(43) Pub. Date: Sep. 18, 2025

(54) METHOD AND SYSTEM FOR DEVELOPING A TRAINING SET FOR A MACHINE LEARNING ALGORITHM

(71) Applicant: Amida Technology Solutions, Inc., Washington, DC (US)

(72) Inventors: Afsin Ustundag, Rockville, MD (US); Manish Mithaiwala, Reston, VA (US); Danielle Jeanette Nelson, Glenwood, MD (US); Yao Ma, Cohoes, NY (US); Peter L Levin, Silver Spring, MD (US)

(73) Assignee: Amida Technology Solutions, Inc, Washington, DC (US)

(21) Appl. No.: 19/082,696

(22) Filed: Mar. 18, 2025

Related U.S. Application Data
(60) Provisional application No. 63/566,485, filed on Mar. 18, 2024.

(51) Int. Cl. G06F 18/214

(52) U.S. Cl. CPC G06F 18/214

(57) ABSTRACT

A computer implemented method for developing a training set for a machine learning algorithm (MLA). A selected relation-based model of a selected system is transformed into a corresponding graph-based model. Target nodes in the graph model are embedded into a selected embedding space as a function of an improved loss function that tends to cluster the target nodes as a function of their similarity. Based on their similarity, target nodes are selected for inclusion in the training set for the MLA.

### CROSS-REFERENCE TO RELATED APPLICATIONS

This application is related to U.S. Provisional Patent Application Ser. No. 63/566,485, filed 18 Mar. 2024, entitled “Method and System for Using Graph Databases to Determine and Shape Artificial Intelligence/Machine Learning Training Sets” (“Parent Provisional Application”).

This application claims priority to the Parent Application and hereby claims benefit of the filing dates thereof pursuant to 37 CFR § 1.78(a)(4).

The subject matter of the Parent Application is expressly incorporated herein by reference.

### FIELD OF INVENTION

The present invention relates to the field of machine learning algorithms (MLA). In particular, a graph embedding based outlier filtering methodology together with an improved loss function facilitate development of better training sets for MLAs.

### BACKGROUND

In general, in the descriptions that follow, the first occurrence of each special term of art that should be familiar to those skilled in the art of machine learning algorithms (MLAs) will be italicized. In addition, when a term that may be new or that may be used in a context that may be new, that term will be set forth in bold and at least one appropriate definition for that term will be provided.

In general, the field of MLAs is, today, well documented in the many published reports and studies readily accessible via the Web. With reference to this large body of research, we note that our invention relates not to MLAs per se, but only to techniques for developing training sets for MLA. In this regard, we submit that presently known techniques tend to collect too many outliers that reduce the efficiency of the learning process. We submit that an improved technique is needed to reduce the number of outliers selected for inclusion in the training sets.

### BRIEF SUMMARY OF THE INVENTION

According to one embodiment, we provide a MLA, the method comprising the steps of:
[1.1] selecting a relation-based model of a selected system comprising:
   [1.1.1] a set of attributes;
   [1.1.2] a first target of interest having associated therewith a first attribute selected from the attribute set;
   [1.1.3] a second target of interest having associated therewith a second attribute selected from the attribute set; and
   [1.1.4] a third target of interest having associated therewith a third attribute selected from the attribute set;
[1.2] transforming the relation-based model into a graph-based model comprising:
   [1.2.1] a first target node corresponding to the first target of interest;
   [1.2.2] a second target node corresponding to the second target of interest;
   [1.2.3] a third target node corresponding to the third target of interest;
   [1.2.4] a first context node corresponding to the first attribute;
   [1.2.5] a first edge connecting the first target node to the first context node;
   [1.2.6] if the second attribute is the same as the first attribute:
      [1.2.6.1] a second edge connecting the second target node to the first context node;
   [1.2.7] else:
      [1.2.7.1] a second context node corresponding to the second attribute; and
      [1.2.7.2] a third edge connecting the second target node to the second context node;
   [1.2.8] if the third attribute is the same as the first attribute:
      [1.2.8.1] a fourth edge connecting the third target node to the first context node;
   [1.2.9] else, if the third attribute is the same as the second attribute:
      [1.2.9.1] a fifth edge connecting the third target node to the second context node;
   [1.2.10] else:
      [1.2.10.1] a third context node corresponding to the third attribute; and
      [1.2.10.2] a sixth edge connecting the third target node to the third context node;
[1.3] generating an embedding into a selected embedding space for each of the target nodes as a function of a predetermined loss function, each embedding comprising a multi-dimension numerical vector;
[1.4] calculating the similarity of each of the target nodes with respect to each of the other target nodes as a function of the respective angles between the respective vectors in the embedding space;
[1.5] searching within the embedding space for a cluster of the target nodes whose calculated angles differ by a selected distance; and
[1.6] if the search finds such a cluster, selecting for inclusion in the training set only the target nodes comprising the cluster.

### BRIEF DESCRIPTION OF THE SEVERAL VIEWS OF THE DRAWINGS

FIG. 1 illustrates, in stylized plan view, one example of the application of our invention to selecting a training set for an MLA;

FIG. 2 illustrates, in flow-diagram form, the primary steps of our method for developing a training set for an MLA; and

FIG. 3, comprising FIGS. 3A, 3B, 3C, 3D and 3E, illustrate respective examples of the possible ways a set of center nodes can be connected to context nodes.

### DETAILED DESCRIPTION

In an effort to reduce the length and complexity of the following description, we have included all of the underlying mathematical principles that form the foundation of our invention in Appendix 1, attached hereto and expressly incorporated herein by reference.

For convenience of reference hereinafter, we shall use the following capitalized terms:
Algorithm means a process flow implemented in the form of computer executable instructions generated using a selected one or more of the currently available programming languages;
Inference means a prediction made by an MLA as a function of a data set presented to the MLA;
Machine Learning algorithm (“MLA”) means a computer implemented algorithm which has been trained on a Training Set to develop Inferences; and
Training Set means a set of data pre-selected for the purpose of training an MLA.

For convenience of reference, both hereinafter in this Specification and in the Claims, we have adopted a step abbreviation protocol as follows:
[x.y.z. . . . ] wherein:
   x is the claim number;
   y is the step within claim x;
   z is the sub-step within a step within a claim; and
   wherein, in dependent claims, step abbreviations comprise insertions into or additions to the step abbreviations set forth in the referenced independent claim.

The following description provides different embodiments for implementing aspects of the present invention. Specific examples of components and arrangements are described below to simplify the explanation. These are merely examples and are not intended to be limiting. For example, the description of a first component coupled to a second component includes embodiments in which the two components are directly connected, as well as embodiments in which an additional component is disposed between the first and second components. In addition, the present disclosure repeats reference numerals in various examples. This repetition is for the purpose of clarity and does not in itself require an identical relationship between the embodiments.

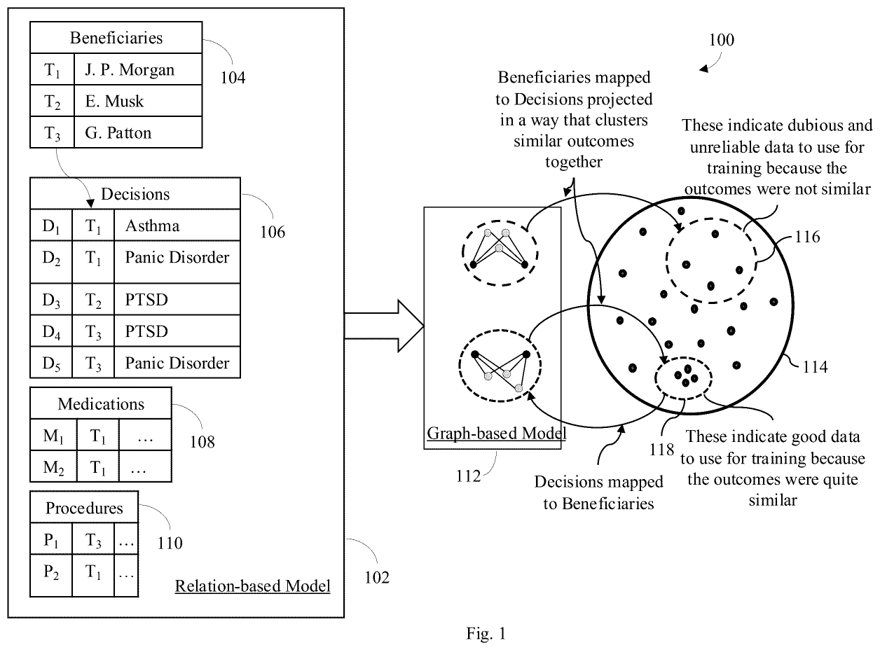

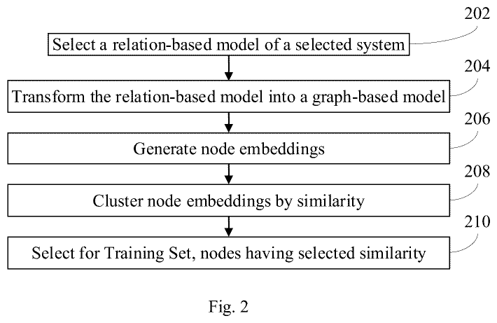

Illustrated in FIG. 1 is one possible application 100 of our invention to selecting a Training Set for an MLA; and the general flow is illustrated in FIG. 2. In this example, in Step 202, we start with a Relation-Based Model 102 implemented using a conventional relational database management system (RDBMS), such as the well-known Structured Query Language (SQL) originally developed by the International Business Machine Corporation (I.B.M.) in the 1970s. By way of example, we have constructed a primary table, labeled “Beneficiaries” 104, and three (3) secondary tables, labeled “Decisions” 105, “Medications” 108, and “Procedures” 110, respectively. As generally indicated by the arrow from the Beneficiaries Table 104 to the Decisions table 106, the index of a Beneficiary in the Beneficiaries Table 104, say “T₁”, can be used to access information related to that Beneficiary but distributed across the secondary tables, say, for example: Decisions D₁ and D₂ stored in the Decisions Table 106; Medications M₁ and M₂ stored in the Medications Table 108; and Procedure P₂ stored in the Procedures Table 110. Of course, the size and number of tables will vary depending on the context of the application.

Then, in Step 204, we use a RDBMS-to-graph conversion tool, such as the PyTorch Geometric library (available at: https://github.com/pyg-team/pytorch_geometric), to convert our Relation-Based Model 102 to a Graph-Based Model 112. In general, each of the Beneficiaries in the Beneficiaries Table 104 will be converted into a center node of the Graph Model 112, and each of the attributes in the secondary tables will be converted into a context node of the Graph Model 112. For convenience of reference herein, we may refer to a center node as a target node when, in context, that particular node represents a target of interest. Depending on the application, the number of secondary tables selected for conversion will vary, but each included table will add additional context nodes and edges to the Graph Model 112.

Then, in Step 206, we use a known graph-to-vector embedding algorithm, node2vec (available at: https://snap.stanford.edu/node2vec/), to embed (or map, or project) the center nodes of the Graph Model 112 onto the surface of an embedding space 114. During this embedding process, a multi-dimension vector is calculated for each of the center nodes as a function of the context nodes connected to the respective center node by edges. For convenience of reference, we may hereafter refer to the embedding space 114 as the “Decision Space” since it, in effect, does represent one possible mapping of the Beneficiaries as a function of the Decisions related thereto by way of the Decisions Table 106. As is known, the distance between each of the Beneficiaries comprising the Decision Space can be calculated as a function of the cosine between the respective embedding vector pairs.

In the attached Appendix 1, we have described in detail the mathematical transformations and processes for performing the embedding function. In the course of developing these procedures, we discovered that the quality of the embedding process can be improved by utilizing a better loss function that we have developed. For ease of reference, we include here that loss function:

$$ℒ = - {Σ}_{n = 1}^{{N}_{v}} [ {Σ}_{m ∈ {N}_{n}} log {ϕ}_{n} ( cos {θ}_{n m} ) + {Σ}_{m ∉ {N}_{n}} log ( 1 - {ϕ}_{n} ( cos {θ}_{n m} ) ) ] \qquad ( 0.1 )$$

and direct the reader's attention to the relevant portions of the Appendix 1 for the definitions of the several components comprising this function.

In general, as noted in FIG. 1, the embedding process tends to embed each Beneficiary into a unique location on the surface of the Decision Space 114 in a way that clusters similar outcomes, e.g., Decisions, together. By way of example, we have illustrated two such clusters, Cluster_1 116 and Cluster_2 118. In Cluster_1 116, the distances between the embedded Beneficiaries tend to be relatively larger when compared to, say, the distances between the Beneficiaries in Cluster_2 118. In general, the distance threshold for visualizing clusters will vary depending on the application, and may be dynamically adjusted to better fit the distributions depicted in specific Decision Spaces. In general, this search process tends to be rather heuristic. The goal, however, is to attempt to identify embeddings that are of dubious value when considered for use during the training process of the desired MLA. Thus, in Step 210, we select for inclusion in the Training Set only those Beneficiaries that have sufficient similarity as a function of the selected cluster topography.

We will now apply our invention to a specific embodiment of a Relation-Based Model comprising the following two (2) tables, composed in SQL:

```
CREATE TABLE ‘beneficiaries‘
(
  ‘beneficiary_id‘ int(10) unsigned AUTO_INCREMENT,
  ‘beneficiar_name‘ varchar(10),
  PRIMARY KEY (‘beneficiary _id‘)
) ENGINE=InnoDB DEFAULT CHARSET=utf8;
```

wherein:
   the field ‘beneficiary_id’ comprises the unique index of a Beneficiary;
   the field ‘beneficiary_name’ comprises the unique name of a Beneficiary;
   the InnoDB is the particular MySQL ENGINE I have selected; and
   the DEFAULT CHARSET I have selected is utf8.

```
CREATE TABLE ‘decisions‘
(
  ‘decision_id‘ int(10) unsigned AUTO_INCREMENT,
    ‘beneficiary_id‘ int(10),
  ‘decision_description‘ text,
  PRIMARY KEY (‘beneficiary _id‘)
) ENGINE=InnoDB DEFAULT CHARSET=utf8;
```

wherein:
   the field ‘decision_id’ comprises the unique index of a Decision;
   the field ‘beneficiary_id’ comprises the unique id of a Beneficiary;
   the field ‘decision_description’ comprises the unique description of a Decision;
   the InnoDB is the particular MySQL ENGINE I have selected; and
   the DEFAULT CHARSET I have selected is utf8.

We then populate these tables, i.e., Tables 104 and 106, as illustrated in FIG. 1.

Using the step abbreviations set forth in claim 1, below, we will now demonstrate how the relation-based model can be easily converted into the graph-based model [112]:
perform Step [1.2.1] to create a first target node [T₁] corresponding to the first target of interest [J. P. Morgan];
perform Step [1.2.2] to create a second target node [T₂] corresponding to the second target of interest [E. Musk];
perform Step [1.2.3] to create a third target node [T₃] corresponding to the third target of interest [G. Patton];
perform Step [1.2.4] to create a first context node [D₁] corresponding to the first attribute [Asthma];
perform Step [1.2.5] to create a first edge [E1] connecting the first target node [T₁] to the first context node [D₁].

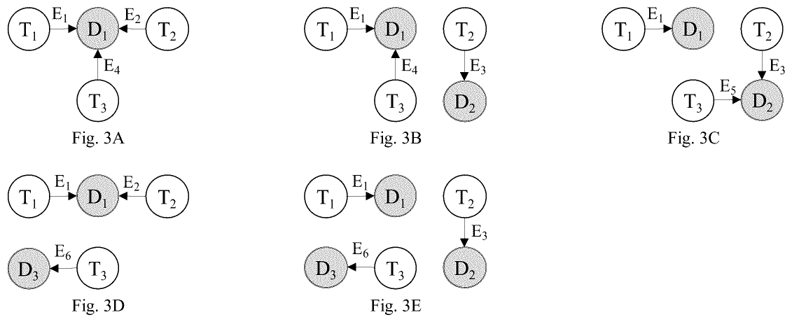

We have now built the base portion of our Graph-Based Model 112. Let us now add the missing edges:
perform Step [1.2.6] to determine if the second attribute [Asthma] is the same as the first attribute [Asthma]—which is TRUE, so:
   perform Step [1.2.6.1 to add a second edge [E2] connecting the second target node [T₂] to the first context node [D₁];
      and, since the test we performed in Step [1.2.6] was TRUE, we can skip Step [1.2.7] and continue to:
perform Step [1.2.8] to determine if the third attribute [Asthma] is the same as the first attribute [Asthma]—which is TRUE, so:
   perform Step [1.2.8.2] to add a fourth edge [E₄] connecting the third target node [T₃] to the first context node [D₁].
      This completes the Graph-Based Model depicted in FIG. 3A.

Let us now see how the flow works with the slightly different Graph-Based Model depicted in FIG. 3B. Beginning, as before, with the base configuration comprising Steps [1.2.1]-[1.2.5], we now proceed to:
perform Step [1.2.6] to determine if the second attribute [Panic Disorder] is the same as the first attribute [Asthma]—which is FALSE, so we skip to:
   perform Step [1.2.7.1] to add a second context node [D₂] corresponding to the second attribute [Panic Disorder]; and
   perform Step [1.2.7.2] to add a third edge [E₃] connecting the second target node [T₂] to the second context node [D₂];
      but we still need to add an edge, so we:
perform Step [1.2.8] to determine if the third attribute [Asthma] is the same as the first attribute [Asthma]—which is TRUE, so we:
   perform Step [1.2.8.1] to add a fourth edge [E₄] connecting the third target node [T₃] to the first context node [D₁].
      This completes the Graph-Based Model depicted in FIG. 3B.

For the Graph-Based Model depicted in FIG. 3C, we again start with the base configuration comprising Steps [1.2.1]-[1.2.5], and replicate the flow in Para [026], above, up to the last step in which we now:
perform Step [1.2.8] to determine if the third attribute [Panic Disorder] is the same as the first attribute [Asthma]—which is FALSE, so we skip down to:
perform Step [1.2.9] to determine if the third attribute [Panic Disorder] is the same as the second attribute [Panic Disorder]—which is TRUE, so we:
   perform Step [1.2.9.1] to add a fifth edge [E₅] connecting the third target node [T₃] to the second context node [D₂].
      This completes the Graph-Based Model depicted in FIG. 3C.

For the Graph-Based Model depicted in FIG. 3D, we again start with the base configuration comprising Steps [1.2.1]-[1.2.5], and:
perform Step [1.2.6] to determine if the second attribute [Asthma] is the same as the first attribute [Asthma]—which is TRUE, so we:
   perform Step [1.2.6.1] to add a second edge [E2] connecting the second target node [T₂] to the first context node [D₁];
      and, since the test we performed in Step [1.2.6] was TRUE, we can skip Step [1.2.7] and continue to:
perform Step [1.2.8] to determine if the third attribute [PTSD] is the same as the first attribute [Asthma]—which it is NOT, so we skip down to:
perform Step [1.2.9] to determine if the third attribute [PTSD] is the same as the second attribute [Panic Disorder]—which is FALSE, so we skip down to:
perform Step [1.2.10.1] to add a third context node [D₃] corresponding to the third attribute [PTSD]; and
   perform Step [1.2.10.2] to add a sixth edge [E₅] connecting the third target node [T₃] to the third context node [D₃].
      This completes the Graph-Based Model depicted in FIG. 3D.

For the Graph-Based Model depicted in FIG. 3E, we again start with the base configuration comprising Steps [1.2.1]-[1.2.5], and then:
perform Step [1.2.6] to determine if the second attribute [Panic Disorder] is the same as the first attribute [Asthma]—which is FALSE, so we skip to:
   perform Step [1.2.7.1] to add a second context node [D₂] corresponding to the second attribute [Panic Disorder]; and
   perform Step [1.2.7.2] to add a third edge [E3] connecting the second target node [T₂] to the second context node [D₂];
      but this time when we:
perform Step [1.2.8] to determine if the third attribute [PTSD] is the same as the first attribute [Asthma]—which is FALSE, so we skip down to:
perform Step [1.2.9] to determine if the third attribute [PTSD] is the same as the second attribute [Panic Disorder]—which is also FALSE, so we skip down to:
   perform Step [1.2.10.1] to a add third context node [D₃] corresponding to the third attribute [PTSD]; and
   perform Step [1.2.10.2] to add a sixth edge [E₆] connecting the third target node [T₃] to the third context node [D₃].
      This completes the Graph-Based Model depicted in FIG. 3E.

The foregoing explanation described features of several embodiments so that those skilled in the art may better understand the scope of the invention. Those skilled in the art will appreciate that they may readily use the present disclosure as a basis for designing or modifying other processes and structures for carrying out the same purposes and/or achieving the same advantages of the embodiments herein. Such equivalent constructions do not depart from the spirit and scope of the present disclosure. Numerous changes, substitutions and alterations may be made without departing from the spirit and scope of the present invention.

Although illustrative embodiments of the invention have been described in detail with reference to the accompanying drawings, it is to be understood that the invention is not limited to those precise embodiments, and that various changes and modifications can be affected therein by one skilled in the art without departing from the scope of the invention as defined by the appended claims. Thus, it will be apparent to one of ordinary skill that this disclosure provides for improved method and apparatus for use in semiconductor packaging.

Apparatus, methods and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art will appreciate that implementations can be made for other fields of art, systems, apparatus or methods that provide the required functions. The invention should therefore not be limited by the above-described embodiments, methods, and examples, but by all embodiments and methods within the scope and spirit of the invention.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

Terminology used in the present disclosure is intended to include all environments and alternate technologies that provide the same functionality described herein.

1. A computer implemented method for developing a first training set for a machine learning algorithm (MLA), the method comprising the steps of:
[1.1] selecting a relation-based model of a selected system comprising:
[1.1.1] a set of attributes;
[1.1.2] a first target of interest having associated therewith a first attribute selected from the attribute set;
[1.1.3] a second target of interest having associated therewith a second attribute selected from the attribute set; and
[1.1.4] a third target of interest having associated therewith a third attribute selected from the attribute set;
[1.2] transforming the relation-based model into a graph-based model comprising:
[1.2.1] a first target node corresponding to the first target of interest;
[1.2.2] a second target node corresponding to the second target of interest;
[1.2.3] a third target node corresponding to the third target of interest;
[1.2.4] a first context node corresponding to the first attribute;
[1.2.5] a first edge connecting the first target node to the first context node;
[1.2.6] if the second attribute is the same as the first attribute:
[1.2.6.1] a second edge connecting the second target node to the first context node;
[1.2.7] else:
[1.2.7.1] a second context node corresponding to the second attribute; and
[1.2.7.2] a third edge connecting the second target node to the second context node;
[1.2.8] if the third attribute is the same as the first attribute:
[1.2.8.1] a fourth edge connecting the third target node to the first context node;
[1.2.9] else, if the third attribute is the same as the second attribute:
[1.2.9.1] a fifth edge connecting the third target node to the second context node;
[1.2.10] else:
[1.2.10.1] a third context node corresponding to the third attribute; and
[1.2.10.2] a sixth edge connecting the third target node to the third context node;
[1.3] generating an embedding into a selected embedding space for each of the target nodes as a function of a predetermined loss function, each embedding comprising a multi-dimension numerical vector;
[1.4] calculating the similarity of each of the target nodes with respect to each of the other target nodes as a function of the respective angles between the respective vectors in the embedding space;
[1.5] searching within the embedding space for a cluster of the target nodes whose calculated angles differ by a selected distance; and
[1.6] if the search finds such a cluster, selecting for inclusion in the first training set only the target nodes comprising the cluster.

2. The method of claim 1 further comprising the step of:
[1.7] if the search finds no such cluster, selecting for inclusion in the training set all of the target nodes.

3. The method of claim 1 further comprising the step of:
[1.8] if the search finds no such cluster, selecting for inclusion in the training set none of the target nodes.

4. The method of claim 1 wherein, in step [1.3], the loss function comprises:
$$ℒ = - {Σ}_{n = 1}^{{N}_{v}} [ {Σ}_{m ∈ {N}_{n}} log {ϕ}_{n} ( cos {θ}_{n m} ) + {Σ}_{m ∉ {N}_{n}} log ( 1 - {ϕ}_{n} ( cos {θ}_{n m} ) ) ] .$$

5. The method of claim 1 further comprising the step of:
[1.9] if the search finds such a cluster, selecting for inclusion in a second training set at least a selected one of the target nodes not comprising the cluster.
